(19) United States
(12) Patent Application Publication
(10) Pub. No.: US 2026/0105402 A1
(43) Pub. Date: Apr. 16, 2026

(54) ESTIMATING AND OPTIMIZING PERFORMANCE OF AN INDUSTRIAL ASSET

(71) Applicant: Honeywell International Inc., Charlotte, NC (US)

(72) Inventors: Sahil Vartak, Atlanta, GA (US); Junda Zhu, Atlanta, GA (US); Sabina Azizli, Fulshear, TX (US); Mitchell O'Brien, Tempe, AZ (US)

(21) Appl. No.: 18/915,406

(22) Filed: Oct. 15, 2024

(51) Int. Cl. G06Q 10/0639; G06Q 10/04

(52) U.S. Cl. CPC G06Q 10/0639; G06Q 10/04

(57) ABSTRACT

Approaches for estimating and optimizing performance of an industrial asset are described. In an example, a set of values of an operational parameter of the industrial asset installed within a networked environment are obtained. Thereafter, the set of values is analyzed to identify a trend within the operational parameter values. The identified trend, along with the set of values, is then used as input to a machine learning model to estimate the value of a performance indicator for the asset. In another example, a desired performance indicator value may be obtained and used in the estimation model to determine optimal operational parameter values to achieve the specified performance. In an example, the estimation model is trained using historical data comprising operational parameters and corresponding performance indicators. Based on the estimated values, the estimation system may generate recommendations for optimizing asset performance or implementing necessary adjustments to achieve desired outcomes.

### BACKGROUND

Industrial assets are equipment, machinery, and systems used in manufacturing, processing, or production facilities to transform raw materials into finished products or provide essential services. Examples of such assets include chemical processing units, refining units, power generation units, manufacturing equipment, and material handling systems. To ensure optimal and efficient performance, such industrial assets may be monitored to check if the asset under consideration is deviating from its otherwise performant operation. This may involve tracking various controllable variables and evaluating key performance indicators of the asset.

### BRIEF DESCRIPTION OF FIGURES

Systems and/or methods, in accordance with examples of the present subject matter are now described and with reference to the accompanying figures, in which:

FIG. 1 illustrates a computing system for estimating a performance indicator of an asset, as per an example;

FIG. 2 illustrates a networked industrial environment comprising an estimation system, as per an example;

FIG. 3 illustrates a computing system for training an estimation model, as per an example;

FIG. 4 illustrates a computing system for estimating a performance indicator of an asset, as per an example;

FIG. 5 illustrates a computing system for training an estimation model, as per another example;

FIG. 6 illustrates a computing system for estimating an operational parameter of an asset, as per an example;

FIG. 7 illustrates a user interface presented by a display interface to an operator for obtaining a desired performance indicator value, as per an example;

FIG. 8 illustrates a method for estimating a performance indicator an asset, based on a trained estimation model, as per an example;

FIG. 9 illustrates a method for training an estimation model and estimating a performance indicator of a target asset, based on a trained estimation model, as per an example;

FIG. 10 illustrates a method for training an estimation model and estimating an operational parameter of a target asset, based on a trained estimation model, as per an example; and

FIG. 11 illustrates a system environment implementing a non-transitory computer readable medium for estimating one of a performance indicator or an operational parameter, based on a trained estimation model, as per an example.

### DETAILED DESCRIPTION

A networked industrial environment may include a plurality of interconnected equipment, control systems, and processes which are typically found in manufacturing facilities, refineries, chemical plants, and other industrial settings. Such networked environments may further include industrial assets interconnected with each other to manufacture finished goods or products. Examples of such industrial assets include, but are not limited to, chemical processing unit, petrochemical processing unit, refining unit, oil and gas production unit, power generation unit, manufacturing unit, material handling unit, water treatment unit, food processing unit, unit, water treatment unit, food processing unit, among others.

To ensure optimal operation of the entire industrial environment, each asset must operate in a performant manner, either independently or in conjunction with other assets. As may be understood, the performance of any system may be influenced by its operational parameters, which are the controllable variables that affect the system's operation and output. Similarly, the performance of these industrial assets may also be dependent on other operational parameters. These operational parameters are monitored and may be controlled appropriately for maintaining the efficiency and effectiveness of the asset. Examples of such operational parameters include, but are not limited to, temperature, input material composition, input material flow rate, input material temperature, input material pressure, reactor temperature, reactor pressure, reaction time, catalyst type, catalyst concentration, catalyst activity, feed rate, product yield, product composition, product quality metrics, energy consumption, utility consumption, equipment efficiency metric, among others.

If these controllable variables are maintained within optimal ranges, the asset is more likely to operate in a predictable and efficient manner. The performance of the asset may be evident through a plurality of key performance indicators (KPIs), which provide quantitative measures of the asset's efficiency, productivity, and output quality. These KPIs indicate whether the unit is operating in a performant manner or if adjustments in controllable variables are required. Examples of KPIs may include product yield, product quality metrics, conversion efficiency, energy efficiency, resource utilization efficiency, throughput, production rate, product recovery rate, product composition, among others.

Conventionally, estimation of the performance indicators or the performance of industrial assets is done using two primary techniques, i.e., based on expert knowledge and using univariate models. For the former case, using expert knowledge involves experienced operators and engineers using their subjective assessments and understanding of the process to make predictions about the future performance of the asset. This approach may leverage years of hands-on experience and deep familiarity with the specific asset. Univariate models, on the other hand, rely solely on the historical values of the performance indicator itself to predict future values. These models typically assume that the best predictor of future performance is based on recent past performances.

However, such techniques face several technical challenges. For example, estimation of performance of units based on expert knowledge may not consistently account for all relevant factors affecting performance of the asset. Further, it also relies heavily on the availability of experienced personnel. On the other hand, univariate models fail to capture the complex relationships between various controllable variables and performance indicators, often leading to suboptimal predictions. These models do not account for the dynamic nature of industrial processes and the interdependencies between different controllable variables, resulting in limited accuracy and reliability in performance estimation.

Approaches for estimating performance indicator of an industrial asset are described. The estimation of performance indicator, for an example, may be used to optimize operations, schedule timely maintenance, and enhance overall efficiency of the industrial asset under consideration. The industrial asset is part of a networked industrial environment which is to perform a variety of tasks. To this end, an estimation system including an estimation engine may be implemented within the networked environment for estimating a performance indicator of the industrial asset. In an example, the estimation system obtains set of values of an operational parameter of the industrial asset. The operational parameter indicates measurable variables that affect an asset's performance.

Thereafter, the estimation engine analyses the set of values of operational parameters to identify a trend within the set of values of operational parameter. In an example, the trend indicates one of a consistent pattern and direction of change observed in the values of operational parameters over time. It may show how the values are generally increasing, decreasing, or fluctuating in a particular manner. The identified trend along with the set of values of operational parameters are then used in a machine learning model as input to estimate the value of the performance indicator. Once estimated, the value of the performance indicator is used for generating an estimation report for the industrial asset.

In an example, the machine learning model is trained based on a training data comprising training operational parameter and corresponding training performance indicator. In an example, the training data is processed to analyze a trend associated with the training set of values of the training operational parameter. As described above as well, the trend indicates one of a consistent pattern and direction of change observed in the values of operational parameters over time. The analyzed trend along with the training operational parameter values and correlated training performance indicator values may be used to train the model. As a result of this, the trained model is capable of estimating the value of a performance indicator based on values of operational parameter of a target asset.

In another example, the estimation model may be trained to estimate a value of an operational parameter for achieving a specified value of a given performance indicator. In such a scenario, the estimation model may also be trained based on a set of training values of a training performance indicator and corresponding training values of an operational parameter. While training, a trend may be identified from the set of training values of the training performance indicator, indicating one of pattern and direction of change, and correlated with the changes observed in the training values of the operational parameter. Once the correlation is done, the estimation model is trained using the correlation information along with the training information.

Once trained, the estimation model may be used to estimate the value of the operation parameter which may be applied to the asset to achieve the desired value of the performance indicator. For example, if operator wants to achieve a specific hydrocarbon number yield in a continuous catalytic reforming (CCR) unit, the estimation model may be used to identify the optimal combination of operational parameters such as weighted average inlet temperature (WAIT), hydrogen to hydrocarbon ratio, feed composition, and reactor pressure and values corresponding to these parameters. On adjusting values of these operational parameters in line with identified values, the industrial asset would be able to achieve the desired performance, i.e., specified value for the performance indicator.

As will be explained further, the present approaches enable estimating performance indicators of industrial assets based on operational parameters and identified trends using a trained machine learning model. The machine learning model is trained using training data of operational parameters and corresponding performance indicators from various assets within the networked industrial environment. Since the machine learning model learns from the complex relationships between operational parameters and performance indicators across multiple assets, it may provide accurate estimations for individual assets under various operating conditions. Conversely, with the trained estimation model, appropriate operational parameters may be determined to achieve specified performance indicators. These capabilities allow for optimized asset performance, proactive maintenance scheduling, and improved decision-making within the industrial organization. These and other approaches are further explained in conjunction with the accompanying figures.

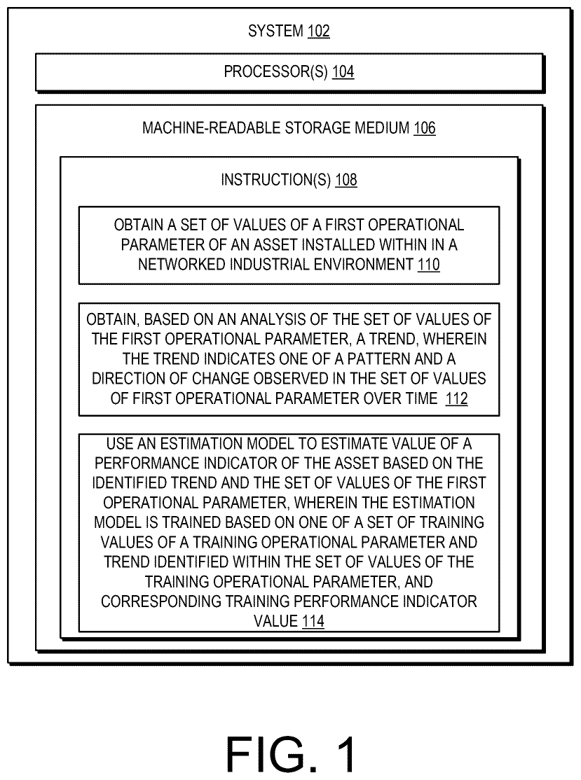

FIG. 1 illustrates an example system 102 for estimating a performance indicator of an asset installed within a networked environment. The estimation of performance indicator is based on a set of values of one or more operational parameters observed for the asset over a period of time, in accordance with an example of the present subject matter. The set of values may reflect the asset's operational history or current conditions. The system 102 includes a processor 104, and a machine-readable storage medium 106 which is coupled to, and accessible by, the processor 104. The system 102 may be implemented in any computing system, such as a storage array, server, desktop or a laptop computing device, a distributed computing system, or the like. Although not depicted, the system 102 may include other components, such as interfaces to communicate over the network or with external storage or computing devices, display, input/output interfaces, operating systems, applications, data, and the like, which have not been described for brevity.

The processor 104 may be implemented as a dedicated processor, a shared processor, or a plurality of individual processors, some of which may be shared. The machine-readable storage medium 106 may be communicatively connected to the processor 104. Among other capabilities, the processor 104 may fetch and execute computer-readable instructions, including instructions 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like. The instructions 108 may be executed to classify the hardware components of the computing device.

In an example, the processor 104 may fetch and execute instructions 108. In one example, as a result of the execution of the instructions 110, the system 102 may obtain a set of values of a first operational parameter of an asset installed within a networked industrial environment. The asset may be a piece of industrial equipment or machinery that is part of the production or manufacturing process. In an example, the operational parameter may include measurements such as temperature, pressure, flow rate, or other relevant metrics that indicate the asset's current operating conditions. The values of these operational parameters may be obtained directly from sensors on the asset or from an intermediate data storage system where such information is collected and stored.

Once obtained, the instructions 112 may be executed to obtain a trend within the set of values of the first operational parameter based on the analysis of the set of values of the first operational parameter. The trend thus determined may reflect the pattern or variations in the values of the first operational parameter. In an example, the trend may include instances where the first operational parameter remains constant over a time interval, or may include variations in the values of the first operational parameter. In an example, the trend identification is performed by statistical analysis techniques such as time series analysis, regression analysis, or moving averages.

Once the trend in the first operational parameter values is identified, the instructions 114 may be executed to use an estimation model to estimate the value of a performance indicator of the asset based on the identified trend and the values of the first operational parameter. Different types of trends identified within the set of values of operational parameters may have different effects on the value of the performance indicator. To this end, based on the identified trend in the set of values of the first operational parameter, the value of the performance indicator is estimated for the asset.

The estimation model is trained based on the training data, which includes training operational parameter values and corresponding performance indicator values. Once trained, the trend identified in the values of operational parameters may be used to estimate the value of the performance indicator for the industrial asset.

The above functionalities performed as a result of the execution of the instructions 108, may be performed by different programmable entities. Such programmable entities may be implemented through neural network-based computing systems, which may be implemented either on a single computing device, or multiple computing devices. As will be explained, various examples of the present subject matter are described in the context of a computing system for training a neural network-based model, and thereafter, utilizing the neural network model for estimating value of performance indicator by using actual operational metrics of the asset based on the estimation model. These and other examples are further described with respect to other figures.

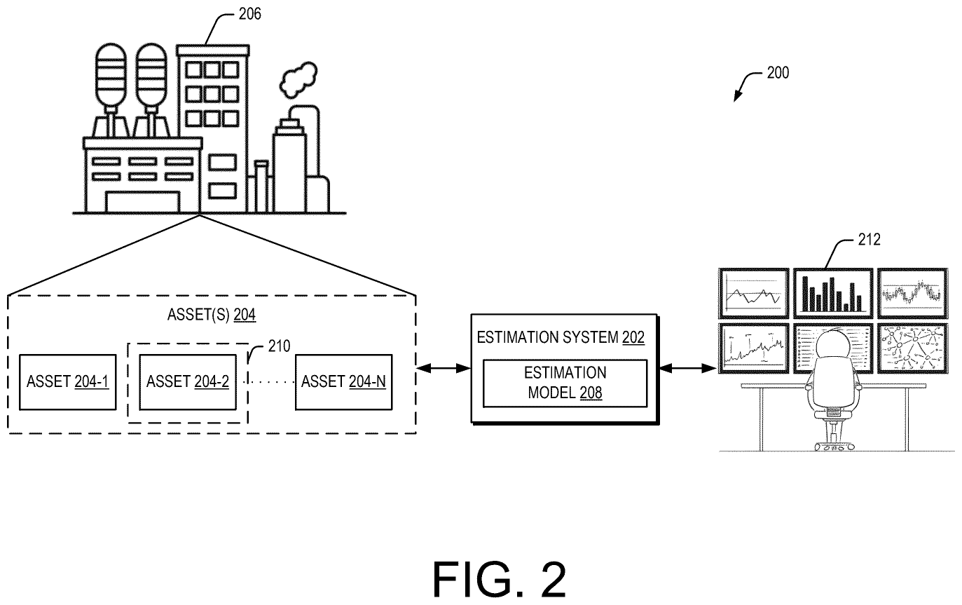

FIG. 2 illustrates a networked industrial environment 200 (referred to as environment 200) comprising an estimation system 202. The estimation system 202 (referred to as system 202) is used for estimating one of a performance indicator value or an operational parameter value, in response to a set of operational parameters observed in relation to assets present within the environment 200 over a period of time or in response to a desired performance indicator value, respectively.

The environment 200 further include a plurality of assets 204-1, 204-2, . . . , 204-N (collectively referred to as asset(s) 204) installed within an industrial organization 206. These asset(s) 204 may include various types of industrial equipment such as chemical processing unit, petrochemical processing unit, refining unit, oil and gas production unit, power generation unit, manufacturing unit, material handling unit, water treatment unit, food processing unit, unit, water treatment unit, food processing unit, pharmaceutical production unit, paper processing unit, metallurgical processing unit, mining and mineral processing unit, textile processing units, electronics manufacturing unit, automotive manufacturing units, aerospace manufacturing unit, waste management unit, renewable energy production unit, agricultural processing unit, and biotechnology processing unit. Specific examples may include CCR units, distillation columns, fluid catalytic cracking (FCC) units, hydrotreating units, steam crackers, polymerization reactors, boilers, compressor stations, heat exchanger networks, cooling towers, electrolysis cells, absorption towers, crystallization units, fermentation tanks, extruders, and filtration units. Each of these asset(s) 204 may have multiple operational parameters that may be monitored and adjusted to optimize performance. The asset(s) 204 may be interconnected and may work in conjunction with each other to produce finished goods or products within the industrial organization 206.

The system 202 further includes an estimation model 208 which is trained based on training data comprising training operational parameter values and corresponding performance indicator values. The example training data may encompass a wide range of operating conditions and scenarios experienced by the asset(s) 204 over time. During training, the model may observe or learn the relationship between the operational parameter values, trend within the operational parameter values and corresponding correlated performance indicator values, to make estimations of performance indicator value.

Once trained, the estimation model 208 is implemented within the system 202 to obtain the current operational parameter values from one of the asset(s) 204, such as a target asset 210 (whose Performance Indicators needs to be estimated) and estimate the value of a performance indicator based on operational parameter values of the target asset 210, wherein the obtained operational parameter values indicate current operating conditions of a target asset 210.

In another example, the estimation model 208 may also be trained to estimate value of operational parameter in response to receiving a request indicating a desired performance indicator value. During training, the estimation model 208 learns the relationships between various performance indicators values and their corresponding operational parameter values using the training data. Once trained, when given a desired performance indicator value, the estimation model 208 estimates the optimal operational parameter values that are likely to achieve the desired performance. In an example, an operator working on a workstation 212 may provide the desired performance indicator value via a user interface to the system 202 through a network (not shown in FIG. 2).

Although the present example depicts the system 202 to be directly coupled to the industrial asset(s) 204, the system 202 may be coupled to other intermediate computing devices or systems, such as process control systems, data acquisition systems, or centralized monitoring platforms, which facilitates data collection, preprocessing, or distribution, without deviating from the scope of the present subject matter. Further details regarding the training process and inference capabilities of the estimation model 208 are described in conjunction with the disclosure of subsequent figures.

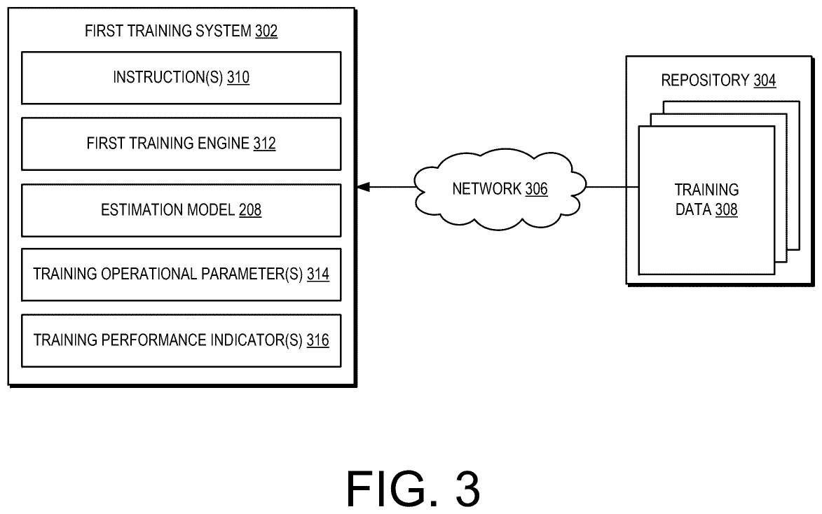

The estimation model 208 to estimate value of performance indicator of an asset based on the input values of an operational parameter may have to be trained which is further explained in conjunction with FIG. 3. FIG. 3 illustrates a first training system 302 comprising a processor or memory (not shown), for training an estimation model to estimate a value of a performance indicator. In an example, the first training system 302 (referred to as system 302) may be communicatively coupled to a repository 304 through a network 306. The repository 304 may further include training data 308. The training data 308 may include training values of operational parameters and corresponding performance indicator values obtained from reference industrial assets operating under known conditions.

In an example, the operational parameters may include input material composition, input material flow rate, input material temperature, input material pressure, reactor temperature, reactor pressure, reaction time, catalyst type, catalyst concentration, catalyst activity, feed rate, product yield, product composition, product quality metrics, energy consumption, utility consumption, equipment efficiency metric, process control variables, environmental conditions, equipment vibration levels, equipment wear indicators, maintenance schedules, production rate, inventory levels, raw material costs, product market prices, equipment uptime, equipment downtime, safety indicators, emissions levels, waste generation rates, recycling rates, labor utilization, or various combinations thereof.

It may be noted that the above-described examples of operational parameters are related to various kinds of assets installed in an industrial environment irrespective of the field to which the industrial environment relate to. The above-described operational parameters may be divided into different sets based on the specific type of industries in which the asset is installed. For example, in case of a CCR unit installed within a refinery industry, the operational parameters may include hydrocarbon yield, actual delta temperature, WAIT, hydrogen to Hydrocarbon ratio, feed nitrogen content, spent coke content, feed naphthene content, feed aromatics content, feed paraffins content, liquid hourly space velocity (LHSV), average reactor pressure, feed naphthene to aromatics ratio, average catalyst chloride content, and mass feed rate.

On the other hand, examples of performance indicators may include, but are not limited to, product yield, product quality metrics, conversion efficiency, energy efficiency, resource utilization efficiency, throughput, production rate, product recovery rate, product composition, product purity, catalyst performance metrics, equipment efficiency, process stability indicators, cycle time, environmental impact metrics, safety performance indicators, equipment reliability metrics, maintenance efficiency, inventory turnover, customer satisfaction metrics, on-time delivery rate, defect rate, waste reduction metrics, resource consumption rate, emissions levels, compliance metrics, and productivity indicators. Similar to operational parameters, the performance indicators may be divided into different sets based on the specific type of industries in which the asset is installed. For example, in case of CCR unit, the performance indicators may include hydrocarbon yield, reformate octane number, conversion rate, product purity, energy efficiency, catalyst activity, throughput, product recovery, hydrogen yield, sulphur content, aromatics content, pressure drop, cycle length, and operating margin.

The training data 308, although depicted as being obtained from a single repository, such as repository 304, may also be obtained from multiple other sources without deviating from the scope of the present subject matter. In such cases, each of such multiple repositories may be interconnected through a network, such as the network 306.

The network 306 may be a private network or a public network and may be implemented as a wired network, a wireless network, or a combination of a wired and wireless network. The network 306 may also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

The system 302 may further include instructions 310 and a first training engine 312. In an example, the instructions 310 are fetched from a memory and executed by a processor included within the system 302. The first training engine 312 may be implemented as a combination of hardware and programming, for example, programmable instructions to implement a variety of functionalities. In examples described herein, such combinations of hardware and programming may be implemented in several different ways. For example, the programming for the first training engine 312 may be executable instructions, such as instructions 310. Such instructions may be stored on a non-transitory machine-readable storage medium which may be coupled either directly with the system 302 or indirectly (for example, through networked means). In an example, the first training engine 312 may include a processing resource, for example, either a single processor or a combination of multiple processors, to execute such instructions. In the present examples, the non-transitory machine-readable storage medium may store instructions, such as instructions 310, that when executed by the processing resource, implement the first training engine 312. In other examples, the first training engine 312 may be implemented as electronic circuitry.

The instructions 310 when executed by the processing resource, cause the first training engine 312 to train an artificial intelligence based machine learning model, such as an estimation model 208. In an example, the estimation model 208, in context of FIG. 3 is trained based on one of training operational parameters and trend identified within the training operational parameters, and corresponding training performance indicators to estimate a performance indicator value based on input values of operational parameter. The instructions 310 may be executed by the processing resource for training the estimation model 208 based on the training data 308. The system 302 may further include training operational parameter(s) 314 comprising values of various controllable variables that affect the asset's operation and output, such as temperature, pressure, flow rates, catalyst concentrations, and other asset related metrics, and training performance indicator(s) 316 comprising values of quantitative measures of the asset's efficiency, productivity, and output quality, such as product yield, energy efficiency, and product purity. In an example, the system 302 may obtain single training data 308 at one time which may be corresponding to a single asset from the repository 304, and the information pertaining to that is stored as training operational parameter(s) 314 and training performance indicator(s) 316.

In operation, the system 302 may obtain the training data 308 from the repository 304 and data included in the training data 308 may be further stored as training operational parameter(s) 314 and training performance indicator(s) 316 in the system 302. In an example, the training operational parameter(s) 314 and training performance indicator(s) 316 may include set of training values corresponding to each type of operational parameter and each type of performance indicator, respectively.

In an example, the training operational parameter(s) 314 corresponding to which the training values are obtained may be selected based on their correlation with each other in impacting the asset's operation and performance and are determined based on a correlation matrix. The correlation matrix indicates correlation coefficients between pairs of operational parameters, depicting strength and direction of relationships between different variables. To select correlated parameters, the correlation matrix may be processed to identify operational parameters having correlation coefficients greater than a predefined threshold value. It may be noted that, parameters with high correlation coefficients are likely to have significant influence on the asset's performance and may be prioritized for inclusion in the analysis. Conversely, parameters with low correlation coefficients may be excluded.

Continuing further, once the training data 308 is obtained, the first training engine 312 analyze the training operational parameter(s) 314 to determine a trend within the training values. In an example, the trend within the training values indicates one of a pattern and a direction of change observed in the values of the training operational parameter(s) 314. In an example, the trend identification is performed by the system 302 or the first training engine 312 by using statistical analysis techniques such as time series analysis, regression analysis, or moving averages. These techniques may detect patterns, seasonality, and long-term trends in the operational parameter data. Additionally, more advanced techniques like Fourier analysis or wavelet transforms may be employed to identify complex patterns or cyclical behavior in the training values. In another example, the system 302 may also use threshold-based rules to identify sudden changes or anomalies in the operational parameters.

The trend identified within the training operational parameter(s) 314 may include temporal trends as well as the non-temporal trends. In an example, temporal trends are typically identified within the training values of a single operational parameter over time. These temporal trends include short-term fluctuations, long-term trends, cyclic trends, seasonal variations, sudden spikes, sudden drops, periods of stability, rates of change over different time scales, and moving averages. These patterns reveal how a specific operational parameter evolves and behaves over time.

On the other hand, non-temporal trends are generally identified between the training values of multiple operational parameters. These non-temporal trends encompass relationships such as linear correlations, inverse relations, non-linear correlations, hysteresis relations, oscillatory relations, ratio relations, lag relations, conditional relations, and threshold relations. These trends capture the complex interactions and dependencies between different operational parameters, providing insights into how various aspects of the industrial asset's operation influence each other.

Returning to the present example, once the trend within the training values of training operational parameter(s) 314 is identified, the firs training engine 312 may train the estimation model 208 based on one of the training operational parameter(s) 314 and trend determined within the training operational parameter(s) 314, and respective correlated training performance indicator(s) 316. For example, the first training engine 312 may identify an increasing trend in a first operational parameter over time. The first training engine 312 then trains the estimation model 208 to learn the relationship between the identified increasing trend in the first operational parameter with respective values of a first performance indicator.

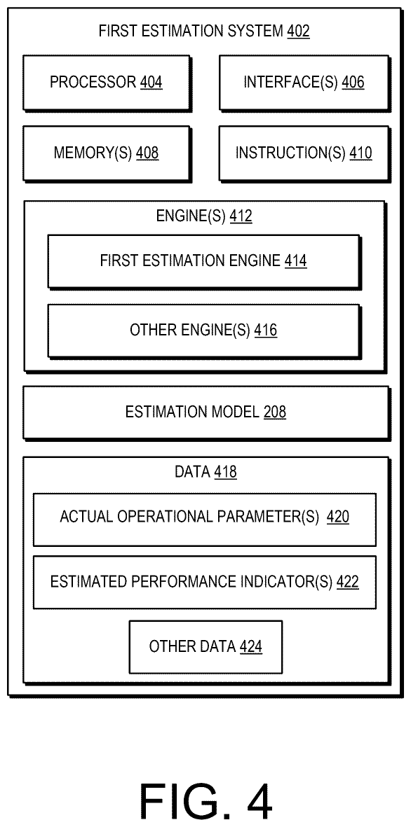

Once trained, the estimation model 208 may be utilized for estimating a value of a performance indicator of an industrial asset based on trends identified in operational parameters of that asset. For example, a set of values of a first operational parameter pertaining to an asset may be processed based on the estimation model 208. In such a case, the system 102 or system 202 analyzes the set of values to identify a trend, which indicates one of a pattern and a direction of change observed in the set of values of first operational parameter over time. The identified trend, along with the set of values, is then used as input to the estimation model 208 to estimate the value of a performance indicator for the asset. The manner in which the value of performance indicator is estimated by the trained estimation model 208 is further described in conjunction with FIG. 4.

FIG. 4 illustrates a first estimation system 402 for estimating a value of a performance indicator of a target asset, such as target asset 210, of an industrial organization, such as 206. In an example, the first estimation system 402 (referred to as system 402) may estimate the value of the performance indicator using the trained estimation model 208. In an example, the estimation model 208, in context of this example, is trained based on one of training operational parameters and trend identified within the training operational parameters, and corresponding training performance indicators to estimate a performance indicator value based on input values of operational parameter.

The system 402 may include a processor 404, interface(s) 406, and memory 408. The processor 404 may be implemented as microprocessors, microcomputers, microcontrollers, digital signal processors, central processing units, state machines, logic circuitries, and/or other devices that manipulate signals based on operational instructions. Among other capabilities, the processor 404 may be configured to obtain a set of values of operational parameters of an asset and analyze these values to identify trends. The processor 404 may then use an estimation model to estimate performance indicator values based on the identified trends. In an example, the processor 404 may also be capable of estimating optimal operational parameter values to achieve target performance indicator values. The estimated performance indicator values or optimal operational parameter values may be used to generate reports or recommendations for optimizing asset performance within the networked industrial environment, such as environment 200.

The interface(s) 406 may allow the connection or coupling of the system 402 with one or more computing devices or industrial assets, such as target asset 210 and workstation 212 through a wired network, a wireless network, or a combination of a wired and wireless network. The interface(s) 406 may also enable intercommunication between different logical as well as hardware components of the system 402.

The memory 408 may be a computer-readable medium, examples of which include volatile memory (e.g., RAM), and/or non-volatile memory (e.g., Erasable Programmable read-only memory, i.e., EPROM, flash memory, etc.). The memory 408 may be an external memory, or internal memory, such as a flash drive, a compact disk drive, an external hard disk drive, or the like. The memory 408 may further include data which either may be utilized or generated during the operation of the system 402.

Similar to the system 102, the system 402 may further include instructions 410 and engine(s) 412. In an example, the instructions 410 are fetched from the memory 408 and executed by the processor 404 included within the system 402. The engine(s) 412 may include a first estimation engine 414 and other engine(s) 416. The other engine(s) 416 may further implement functionalities that supplement functions performed by the system 402 or any of the engine(s) 412.The first estimation engine 414 may be implemented as a combination of hardware and programming, for example, programmable instructions to implement a variety of functionalities. In examples described herein, such combinations of hardware and programming may be implemented in several different ways. For example, the programming for the first estimation engine 414 may be executable instructions, such as instructions 410. Such instructions 410 may be stored on a non-transitory machine-readable storage medium which may be coupled either directly with the system 402 or indirectly (for example, through networked means). In an example, the first estimation engine 414 may include a processing resource, for example, either a single processor or a combination of multiple processors, to execute such instructions. In the present examples, the non-transitory machine-readable storage medium may store instructions, such as instructions 410, that when executed by the processing resource, implement the first estimation engine 414. In other examples, the first estimation engine 414 may be implemented as electronic circuitry.

The system 402 may further include an estimation model, such as estimation model 208, and a data 418. The data 418 may include corresponding data that is utilized or generated by the system 402, while performing a variety of functions. In an example, the data 418 further includes actual operational parameter(s) 420, estimated performance indicator(s) 422, and other data 424. Further, the other data 424, amongst other things, may serve as a repository for storing data that is processed, or received, or generated as a result of the execution of the instructions by the processor 404.

In an example, actual operational parameter(s) 420 (referred to as operational parameter(s) 420) include values corresponding to operational parameters of target asset 210 which is installed within the industrial organization 206 and is under monitoring. The estimated performance indicator(s) 422 (referred to as performance indicator(s) 422) include values corresponding to various performance metric which may be achieved by the target asset 210 if the values of operational parameter(s) 420 are applied to or maintained for the target asset 210.

In operation, initially, the system 402 may obtain a set of values of a first operational parameter of the target asset 210. The set of values of first operational parameter is stored as operational parameter(s) 420. These values may be obtained through various sensors and monitoring systems connected or associated with the target asset 210. The operational parameter(s) 420 may include real-time or actual values of parameters such as temperature, pressure, flow rates, composition, and other relevant metrics specific to the target asset 210. In an example, the actual values of operational parameter(s) 420 include both real-time measurements collected from sensors and control systems of the asset, as well as historical data stored in databases. The historical data may comprise measurements collected over extended periods, ranging from days to months or even years, providing a comprehensive record of the asset's past operational trends and performance. For example, if the target asset 210 is CCR unit, the operational parameter(s) 420 may include data or values on WAIT, hydrogen to hydrocarbon ratio, feed nitrogen content, reactor pressure, and among others. It may be noted that although the operational parameter(s) 420 described above are related to CCR unit, however, any other type of parameters may also be used without deviating from the scope of the present subject matter.

In an example, the operational parameters for which the set of values are obtained may be selected based on their correlation with each other in impacting the asset's operation and performance and are determined based on a correlation matrix. The correlation matrix indicates correlation coefficients between pairs of operational parameters, depicting strength and direction of relationships between different variables. To select correlated parameters, the correlation matrix may be processed to identify operational parameters having correlation coefficients greater than a predefined threshold value. It may be noted that, parameters with high correlation coefficients are likely to have significant influence on the asset's performance and may be prioritized for inclusion in the analysis. Conversely, parameters with low correlation coefficients may be excluded.

Once obtained, the first estimation engine 414 analyze the values comprised in the operational parameter(s) 420 to identify a trend. In an example, the trend indicates one of a pattern and a direction of change observed in the values of the operational parameter(s) 420 over time. The trend may include temporal trends such as short-term fluctuations, long-term trends, cyclic patterns, seasonal variations, sudden spikes or drops, periods of stability, and rates of change over different time scales. It may also include non-temporal trends such as linear correlations, inverse relations, non-linear correlations, hysteresis relations, oscillatory relations, ratio relations, lag relations, conditional relations, and threshold relations between different operational parameters.

It may be noted that the non-temporal trends are identified between more than one operational parameters of the target asset 210. In an example, the first estimation engine 414 may obtain a set of values of a second operational parameter of the asset, in addition to the first operational parameter. The first estimation engine 414 then analyzes the set of values of both the first operational parameter and the second operational parameter to identify trends between these two parameters. This results in identification of complex relationships and interdependencies between different operational parameters that may not be apparent when examining each parameter in isolation. For instance, in a catalytic reforming unit, the first estimation engine 414 might analyze the relationship between the WAIT and the hydrogen to hydrocarbon ratio. The identified trend may indicate how changes in one parameter correlate with changes in the other, such as an inverse relationship where an increase in WAIT corresponds to a decrease in the hydrogen to hydrocarbon ratio.

Once the trend is identified, the first estimation engine 414 may estimate a value of performance indicator, stored in performance indicator(s) 422, wherein the value of performance indicator is estimated to be achieved by the target asset 210 if it continues operation with current conditions. For example, if the identified trend shows a gradual increase in one operational parameter over time, the system 402 may use this information to estimate a corresponding change in a specific performance indicator. In an example, the identified trends in operational parameters and their respective correlated performance indicator values are included in the estimation model 208 while training and then the estimation model 208 is used for estimating the value of performance indicator(s) 422. The estimation model 208 may also consider multiple trends simultaneously, analyzing complex interactions between various operational parameters to estimate values of performance indicator(s) 422.

Once estimated, the first estimation engine 414 include the values estimated for the performance indicator(s) 422 in a recommendation or estimation report. This report provides operators with a forward-looking view of the asset's expected performance. The report may include detailed insights into the estimated performance indicator(s) 422, their trends, and potential implications for asset operation.

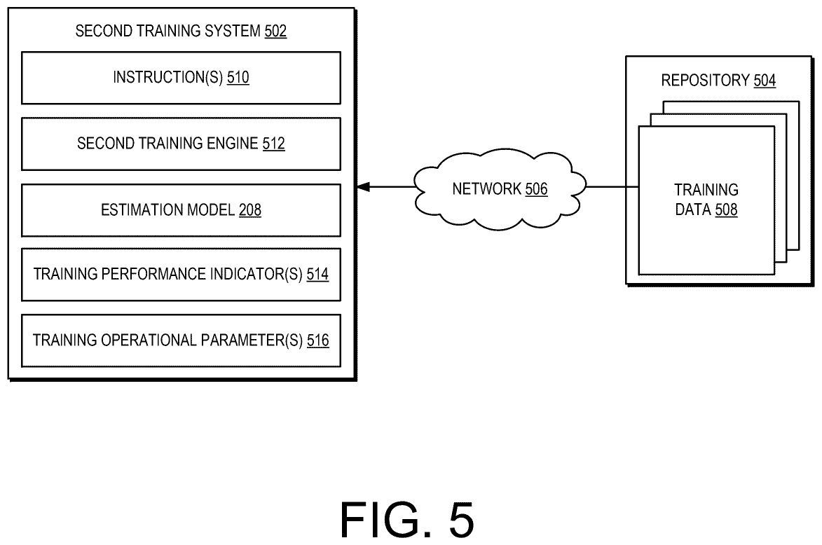

It may also suggest proactive measures or adjustments to operational parameters that could optimize performance or mitigate potential issues. To do so, the estimation model 208 may also be trained to estimate values of operational parameter to achieve a desired performance which is further explained in conjunction with FIG. 5.

FIG. 5 illustrates a second training system 502 comprising a processor or memory (not shown), for training an estimation model, such as estimation model 208, to estimate a value of an operational parameter that, when applied to an asset, is set to achieve a desired performance for the asset. In an example, the second training system 502 (referred to as system 502), similar to system 302, may be communicatively coupled to a repository 504 through a network 506. The repository 504 may further include a training data 508. The training data 508 may include training values of performance indicator and corresponding training values of operational parameters obtained from reference industrial assets operating under known conditions. In an example, the training data 508 is similar to training data 308 as depicted in FIG. 3.

As described in conjunction with FIG. 3, the performance indicator indicates quantitative measures of the asset's efficiency, productivity, and output quality. Some of examples of performance indicators are product yield, product quality metrics, conversion efficiency, energy efficiency, resource utilization efficiency, throughput, production rate, product recovery rate, and product composition. On the other hand, the operational parameter indicates measurable variables that affect an asset's performance. Examples of operational parameters may include temperature, input material composition, input material flow rate, input material temperature, input material pressure, reactor temperature, reactor pressure, reaction time, catalyst type, catalyst concentration, catalyst activity, feed rate, energy consumption, and utility consumption. It may be noted that the above described examples of performance indicators and operational parameters are exemplary and these may include any other type of parameter or indicator without deviating from the scope of the present subject matter.

The training data 508, although depicted as being obtained from a single repository, such as repository 504, may also be obtained from multiple other sources without deviating from the scope of the present subject matter. In such cases, each of such multiple repositories may be interconnected through a network, such as the network 506. The network 506 may be a private network or a public network and may be implemented as a wired network, a wireless network, or a combination of a wired and wireless network, similar to network 306.

The system 302 may further include instructions 510 and a second training engine 512. The instructions 510 when executed by the processing resource, cause the second training engine 512 to train an artificial intelligence-based machine learning model, such as an estimation model 208. In an example, the estimation model 208, in context of FIG. 5 is trained based on one of training performance indicators and trend identified within the training performance indicators, and corresponding training operational parameter to estimate an operational parameter value based on a desired value of performance indicator. The instructions 510 may be executed by the processing resource for training the estimation model 208 based on the training data 508. The system 502 may further include training performance indicator(s) 514 comprising values of quantitative measures of the asset's efficiency, productivity, and output quality, such as product yield, energy efficiency, and product purity and training operational parameter(s) 516 comprising values of various controllable variables that affect the asset's operation and output, such as temperature, pressure, flow rates, and catalyst concentrations. In an example, the system 502 may obtain single training data 508 at one time which may be corresponding to a single asset from the repository 504, and the information pertaining to that is stored as training performance indicator(s) 514 and training operational parameter(s) 516.

In operation, the system 502 may obtain the training data 508 from the repository 504 and data included in the training data 508 may be further stored as training performance indicator(s) 514 and training operational parameter(s) 516 in the system 502. In an example, the training performance indicator(s) 514 and training operational parameter(s) 516 may include set of training values corresponding to each type of performance indicator and each type of operational parameter, respectively.

In an example, the training performance indicator(s) 514 corresponding to which the training values are obtained may be selected based on their correlation with each other in impacting the asset's operation and performance and are determined based on the correlation matrix. The correlation matrix indicates correlation coefficients between pairs of performance indicators, depicting strength and direction of relationships between different indicators. To select correlated indicators, the correlation matrix may be processed to identify performance indicators having correlation coefficients greater than a predefined threshold value. It may be noted that, indicators with high correlation coefficients are likely to have significant influence on the asset's operation. Conversely, indicators with low correlation coefficients may be excluded.

Once the training data 508 is obtained, the second training engine 512 analyze the training performance indicator(s) 514 to determine a trend within the training values. In an example, the trend within the training values indicates one of a pattern and a direction of change observed in the values of the training performance indicator(s) 514. In an example, the trend identification is performed by the system 502 or the second training engine 512 by using statistical analysis techniques such as time series analysis, regression analysis, or moving averages. These techniques may detect patterns, seasonality, and long-term trends in the performance indicator data. Additionally, more advanced techniques like Fourier analysis or wavelet transforms may be employed to identify complex patterns or cyclical behavior in the training values.

As described in conjunction with FIG. 3 as well, the trend identified within the training performance indicator(s) 514 may include temporal trends as well as the non-temporal trends. In an example, temporal trends are typically identified within the training values of a single performance indicator over time. These temporal trends include short-term fluctuations, long-term trends, cyclic trends, seasonal variations, sudden spikes, sudden drops, periods of stability, rates of change over different time scales, and moving averages. These patterns reveal how a specific performance indicator evolves and behaves over time.

On the other hand, non-temporal trends are generally identified between the training values of multiple performance indicators. These non-temporal trends encompass relationships such as linear correlations, inverse relations, non-linear correlations, hysteresis relations, oscillatory relations, ratio relations, lag relations, conditional relations, and threshold relations. These trends capture the complex interactions and dependencies between different performance indicators, providing insights into how various aspects of the industrial asset's performance influence each other.

Returning to the present example, once the trend within the training values of training performance indicator(s) 514 is identified, the second training engine 512 may train the estimation model 208 based on one of the training performance indicator(s) 514 and trend determined within the training performance indicator(s) 514, and respective correlated training operational parameter(s) 516. For example, the first training engine 312 may identify a decreasing trend in a first performance indicator over time. The second training engine 512 then trains the estimation model 208 to learn the relationship between the identified decreasing trend in first performance indicator with respective changes in the values of one or more operational parameters.

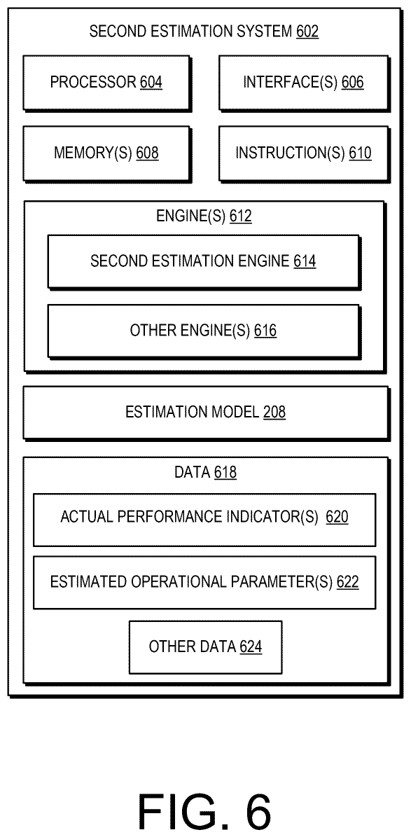

Once trained, the estimation model 208 may be utilized for estimating a value of an operational parameter of an industrial asset to achieve a desired value for an input performance indicator. For example, a desired value of the input performance indicator of a target asset may be processed based on the estimation model 208. In such a case, the system 202 uses the desired value of the input performance indicator as input to the estimation model 208 to estimate the value of an operational parameter, which when applied to the target asset are set to achieve the desired value for the input performance indicator of the target asset. The manner in which the value of operational parameter is estimated by the trained estimation model 208 is further described in conjunction with FIG. 6.

FIG. 6 illustrates a second estimation system 602 for estimating a value of an operational parameter of a target asset, such as target asset 210, of an industrial organization, such as 206. In an example, this estimation is based on a desired value of performance indicator specified by an operator to achieve for the target asset 210. In an example, the second estimation system 602 (referred to as system 602) may estimate the value of the performance indicator based on the trained estimation model 208.

The system 602, similar to system 202, may include a processor 604, interface(s) 606, and memory 608. The processor 604 may be implemented as microprocessors, microcomputers, microcontrollers, digital signal processors, central processing units, state machines, logic circuitries, and/or other devices that manipulate signals based on operational instructions. The interface(s) 606 may allow the connection or coupling of the system 602 with one or more computing devices or industrial assets, such as target asset 210 and workstation 212 through a wired network, a wireless network, or a combination of a wired and wireless network. The interface(s) 606 may also enable intercommunication between different logical as well as hardware components of the system 602.

The memory 608 may be a computer-readable medium, examples of which include volatile memory (e.g., RAM), and/or non-volatile memory (e.g., Erasable Programmable read-only memory, i.e., EPROM, flash memory, etc.). The memory 608 may be an external memory, or internal memory, such as a flash drive, a compact disk drive, an external hard disk drive, or the like. The memory 608 may further include data which either may be utilized or generated during the operation of the system 602.

Similar to the system 202, the system 602 may further include instructions 610 and engine(s) 612. In an example, the instructions 610 are fetched from the memory 608 and executed by the processor 604 included within the system 602. The engine(s) 612 may include a second estimation engine 614, and other engine(s) 616. The other engine(s) 616 may further implement functionalities that supplement functions performed by the system 602 or any of the engine(s) 612.The second estimation engine 614 may be implemented as a combination of hardware and programming, for example, programmable instructions to implement a variety of functionalities. In examples described herein, such combinations of hardware and programming may be implemented in several different ways. For example, the programming for the second estimation engine 614 may be executable instructions, such as instructions 610. Such instructions 610 may be stored on a non-transitory machine-readable storage medium which may be coupled either directly with the system 602 or indirectly (for example, through networked means). In an example, the second estimation engine 614 may include a processing resource, for example, either a single processor or a combination of multiple processors, to execute such instructions. In the present examples, the non-transitory machine-readable storage medium may store instructions, such as instructions 610, that when executed by the processing resource, implement second estimation engine 614. In other examples, the second estimation engine 614 may be implemented as electronic circuitry.

The system 602 may further include an estimation model, such as estimation model 208, and a data 618. The data 618 may include corresponding data that is utilized or generated by the system 602, while performing a variety of functions. In an example, the data 618 further includes performance indicator(s) 620, estimated operational parameter(s) 622, and other data 624. Further, the other data 624, amongst other things, may serve as a repository for storing data that is processed, or received, or generated as a result of the execution of the instructions by the processor 604.

In an example, performance indicator(s) 620 include desired values for specific performance metrics of the asset, such as product yield, conversion efficiency, energy efficiency, or product quality. These target values may represent optimal or desired levels of performance to be achieved for the asset. The estimated operational parameter(s) 622 include values of controllable variables that, when applied to the asset, are predicted to achieve the desired performance indicator(s) 620. These may include parameters such as reactor temperature, pressure, feed rate, catalyst concentration, or other process-specific variables that may be adjusted to influence the asset's performance.

In operation, initially, the system 602 may obtain a desired value of a performance indicator. The desired value of the performance indicator is stored as desired performance indicator(s) 620 and may be provided by an operator or derived from organizational goals. For example, if the target asset 210 is CCR unit, the desired performance indicator might be a specific hydrocarbon yield (yield of C₅₊ carbon, i.e., C5+ yield) or a desired octane number for the reformate. In an example, the system 602 may allow for inputting multiple desired performance indicators simultaneously, such as a combination of several performance indicators. These desired values may be entered by an operator operating on a workstation such as workstation 212 through a user interface.

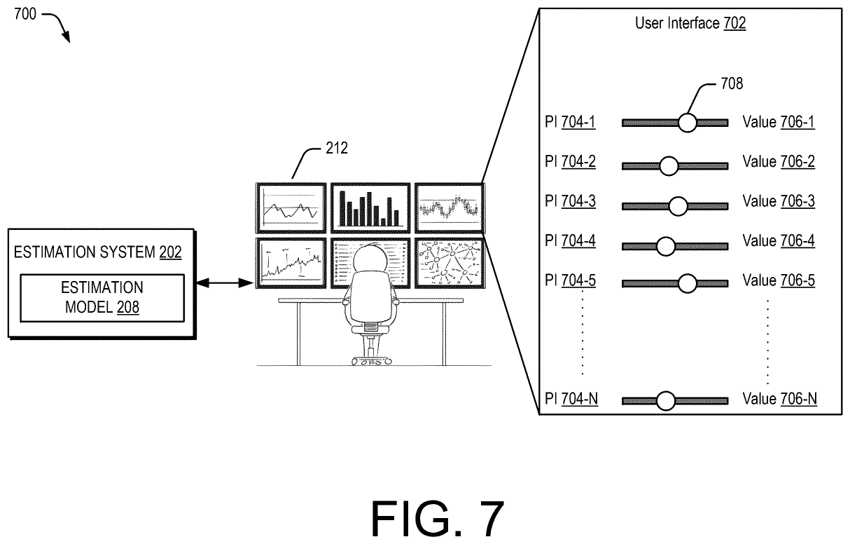

An example implementation of user interface is depicted in FIG. 7. FIG. 7 illustrates a networked industrial environment 700 comprising an estimation system, such as system 202 with an estimation model, such as estimation model 208 connected to a workstation, such as workstation 212 through a network (not shown in FIG. 7). The workstation 212 includes a display interface presenting a user interface 702 to the operator, who may be working at the workstation 212. In an example, the user interface 702 features a plurality of performance indicators 704-1, 704-2, . . . , 704-N (collectively referred to as performance indicator(s) 704) with corresponding values 706-1, 706-2, . . . , 706-N (collectively referred to as value(s) 706) of these performance indicator(s) 704 adjusted using a slider 708 provided for each of the performance indicator(s) 704. In an example, the slider 708 allows the operator to dynamically adjust the value of its associated performance indicator from a minimum value to a maximum value. Using such slider 708, the operator may explore different operational scenarios in real-time, observing how changes in one parameter may affect others through the estimation model 208. In another example, the user interface 702 may also include an input field (not shown in FIG. 7) associated with each performance indicator. Using these fields, the operator may manually enter specific numerical or other types of values for each indicator.

Returning to the present example of FIG. 6, once the desired value of the performance indicator(s) 620 is obtained, the second estimation engine 614 utilizes the estimation model 208 to determine the optimal operational parameters that are needed to achieve the desired value of the performance indicator(s) 620. As described above as well, the estimation model 208 is trained on training data 508 to capture the relationships between operational parameters and performance indicators specific to the target asset 210. In an example, the estimation model 208 considers multiple operational parameters simultaneously to account for their collective impact on the values of the performance indicator(s) 620. For example, in a catalytic reforming unit, it might evaluate combinations of WAIT, hydrogen to hydrocarbon ratio, feed nitrogen content, and reactor pressure to determine their optimal values for achieving the desired hydrocarbon yield or reformate octane number.

Based on the desired value of the performance indicator(s) 620, the second estimation engine 614 subsequently uses the estimation model 208 to estimate values for operational parameters that are likely to achieve the desired performance for the target asset 210. These estimated values for operational parameters are stored in estimated operational parameter(s) 622. Once estimated, the second estimation engine 614 include the values for the estimated operational parameter(s) 622 in a recommendation or estimation report and display the report on the display interface. This report provides operators with actionable insights on how to adjust the asset's operational parameters to achieve the desired performance. In another example, the report includes detailed explanations of the recommended parameter adjustments, potential challenges in implementation, and the expected impact on other performance indicators. The report may also suggest a phased approach for implementing changes, considering factors such as current asset conditions and operational constraints.

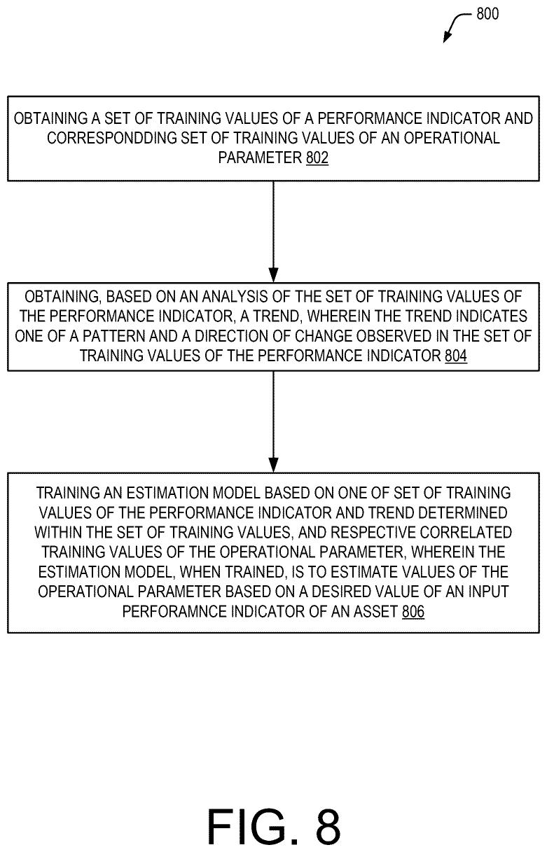

FIG. 8 illustrates example method 800 for training an estimation model, in accordance with examples of the present subject matter. The order in which the above-mentioned method is described is not intended to be construed as a limitation, and some of the described method blocks may be combined in a different order to implement the methods, or alternative methods.

Furthermore, the above-mentioned method 800 may be implemented in suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. For example, the method may be performed by a training system, such as system 502. In an implementation, the method may be performed under an “as a service” delivery model, where the system 502, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 800 may be implemented by the system 502 for training the estimation model 208 based on a training data, such as training data 508. At block 802, training data including a training performance indicator, and a training operational parameter is obtained. For example, the system 502 may obtain the training data 508 from the repository 504 and data included in the training data 508 may be further stored as training performance indicator(s) 514 and training operational parameter(s) 516 in the system 502. In an example, the training performance indicator(s) 514 and training operational parameter(s) 516 may include set of training values corresponding to each type of performance indicator and each type of operational parameter, respectively.

At block 804, a set of training values of the performance indicator is analyzed to identify a trend. For example, the second training engine 512 analyzes the training performance indicator(s) 514 to determine a trend within the training values. In an example, the trend within the training values indicates one of a pattern and a direction of change observed in the values of the training performance indicator(s) 514. In an example, the trend identification is performed by the system 502 or second training engine 512 by using statistical analysis techniques such as time series analysis, regression analysis, or moving averages. These techniques may detect patterns, seasonality, and long-term trends in the performance indicator data. Additionally, more advanced techniques like Fourier analysis or wavelet transforms may be employed to identify complex patterns or cyclical behavior in the training values.

As described in conjunction with FIG. 3 as well, the trend identified within the training performance indicator(s) 514 may include temporal trends as well as the non-temporal trends. In an example, temporal trends are typically identified within the training values of a single performance indicator over time. On the other hand, non-temporal trends are generally identified between the training values of multiple performance indicators.

At block 806, an estimation model may be trained based on one of the set of training values of performance indicator and the trend identified within the set of values, and corresponding correlated operational parameter. For example, the second training engine 512 may train the estimation model 208 based on one of the training performance indicator(s) 514 and trend determined within the training performance indicator(s) 514, and respective correlated training operational parameter(s) 516. For example, the first training engine 312 may identify a decreasing trend in a first performance indicator over time. The second training engine 512 then trains the estimation model 208 to learn the relationship between the identified decreasing trend in first performance indicator with respective changes in the values of one or more operational parameters.

In an example, once trained, the estimation model 208 may be utilized for estimating a value of an operational parameter of an industrial asset to achieve a desired value for a performance indicator. For example, a desired value of a performance indicator of a target asset may be processed based on the estimation model 208. In such a case, the system 202 uses the desired value of the performance indicator as input to the estimation model 208 to estimate the value of an operational parameter, which when applied to the target asset are set to achieve the desired value for the performance indicator of the target asset.

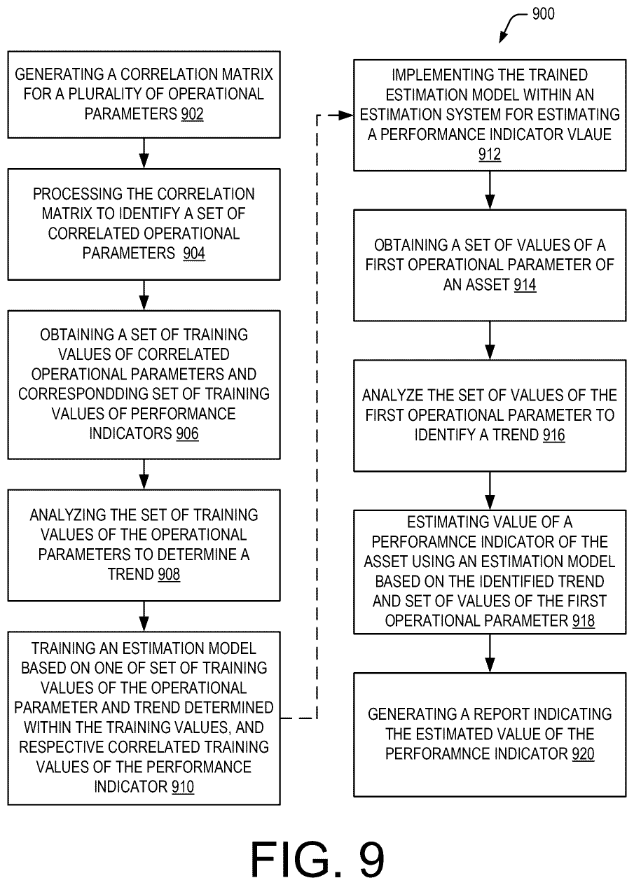

FIG. 9 illustrates another example method 900 for training an estimation model using which a value of a performance indicator may be estimated, and accordingly the estimated value of the performance indicator may be displayed to an operator to take necessary actions. Based on the present approaches as described in the context of the example method, the operational parameters of the industrial asset are analyzed to estimate performance indicators, based on which the performance of the asset is evaluated. The present example method illustrates training of an estimation model and estimating performance indicators an industrial asset, based on such a trained estimation model. It is pertinent to note that such training and eventual estimation of performance indicator may not occur in continuity and may be implemented separately without deviating from the scope of the present subject matter.

At block 902, a correlation matrix for a plurality of operational parameters is generated. For example, the system 302 may generate a correlation matrix that displays correlation coefficients between pairs of operational parameters for an industrial asset, such as target asset 210. This matrix may include parameters such as WAIT, hydrogen to hydrocarbon ratio, feed nitrogen content, reactor pressure, and other relevant operational variables. The correlation coefficients in the matrix indicate the strength and direction of the relationship between each pair of parameters, to identify which parameters are most closely related to each other and to the performance indicators of interest.

At block 904, the correlation matrix is processed to identify a set of correlated operational parameters. For example, the first training engine 312 of the system 302 may process the correlation matrix to identify operational parameters having correlation coefficients greater than a predefined threshold value. The system 302 may then select the training operational parameters from the plurality of available operational parameters based on this analysis of the correlation matrix. These selected parameters are used to train the estimation model 208 for estimating performance indicators or optimal operational parameters for the industrial asset, such as target asset 210.

At block 906, a set of training values of correlated operational parameters and corresponding set of training values of performance indicators are obtained. For example, the system 302 may obtain the training data 308 from the repository 304 and data included in the training data 308 may be further stored as training operational parameter(s) 314 and training performance indicator(s) 316 in the system 302. In an example, the system 302 obtains set of training values of only correlated operational parameters and corresponding training values of performance indicators which are identified or selected based on the analysis of the correlation matrix. In an example, the training operational parameter(s) 314 and training performance indicator(s) 316 may include set of training values corresponding to each type of performance indicator and each type of operational parameter, respectively.

At block 908, the training values of operational parameters are analyzed to determine a trend within the training values. For example, the first training engine 312 analyze the training operational parameter(s) 314 to determine a trend within the training values. In an example, the trend within the training values indicates one of a pattern and a direction of change observed in the values of the training operational parameter(s) 314. In an example, the trend identification is performed by the system 302 or the first training engine 312 by using statistical analysis techniques such as time series analysis, regression analysis, or moving averages. These techniques may detect patterns, seasonality, and long-term trends in the operational parameter data. Additionally, more advanced techniques like Fourier analysis or wavelet transforms may be employed to identify complex patterns or cyclical behavior in the training values.

In an example, the trend identified within the training operational parameter(s) 314 may include temporal trends as well as the non-temporal trends. In an example, temporal trends are typically identified within the training values of a single operational parameter over time. On the other hand, non-temporal trends are generally identified between the training values of multiple operational parameters.

At block 910, an estimation model is trained based on one of set of training values of the operational parameter and trend determined within the training values, and respective correlated training values of the performance indicator. For example, the first training engine 312 may train the estimation model 208 based on one of the training operational parameter(s) 314 and trend determined within the training operational parameter(s) 314, and respective correlated training performance indicator(s) 316. For example, the first training engine 312 may identify an increasing trend in a first operational parameter over time. The first training engine 312 then trains the estimation model 208 to learn the relationship between the identified increasing trend in first operational parameter with respective values of a first performance indicator.

At block 912, the trained estimation mode is implemented within an estimation system for estimating a value of a performance indicator for a target asset. For example, once the estimation model 208 is trained, it may be utilized for analyzing the set of values of operational parameters of a target asset, such as target asset 210, to estimate the value of the performance indicator of the same. Although block 912 is depicted as following block 910, the estimation model may be implemented separately without deviating from the scope of the present subject matter.

At block 914, a set of values of a first operational parameter of a target asset are obtained. For example, the system 402 may obtain a set of values of a first operational parameter of the target asset 210. The set of values of the first operational parameter is stored as operational parameter(s) 420. These values may be obtained through various sensors and monitoring systems connected or associated with the target asset 210. The operational parameter(s) 420 may include real-time or historical values on parameters such as temperature, pressure, flow rates, composition, and other relevant metrics specific to the target asset 210. For example, if the target asset 210 is CCR, the operational parameter(s) 420 may include data or values on WAIT, hydrogen to hydrocarbon ratio, feed nitrogen content, reactor pressure, and among others.

At block 916, the set of values of the first operational parameter are analyzed to identify a trend. For example, the first estimation engine 414 analyzes the values comprised in the operational parameter(s) 420 to identify a trend. In an example, the trend indicates one of a pattern and a direction of change observed in the values of the operational parameter(s) 420 over time. The trend may include temporal trends such as short-term fluctuations, long-term trends, cyclic patterns, seasonal variations, sudden spikes or drops, periods of stability, and rates of change over different time scales. It may also include non-temporal trends such as linear correlations, inverse relations, non-linear correlations, hysteresis relations, oscillatory relations, ratio relations, lag relations, conditional relations, and threshold relations between different operational parameters.

It may be noted that the non-temporal trends are identified between more than one operational parameter of the target asset 210. In an example, the first estimation engine 414 may obtain the set of values of the second operational parameter of the asset, in addition to the first operational parameter. The first estimation engine 414 then analyzes the set of values of both the first operational parameter and the second operational parameter to identify trends between these two parameters. This results in identification of complex relationships and interdependencies between different operational parameters that may not be apparent when examining each parameter in isolation. For instance, in a catalytic reforming unit, the first estimation engine 414 might analyze the relationship between the WAIT and the hydrogen to hydrocarbon ratio. The identified trend may indicate how changes in one parameter correlate with changes in the other, such as an inverse relationship where an increase in WAIT corresponds to a decrease in the hydrogen to hydrocarbon ratio.

At block 918, an estimation model is used to estimate the value of a performance indicator based on the identified trend and the set of values of the first operational parameter. For example, the first estimation engine 414 may estimate a value of performance indicator, stored in performance indicator(s) 420, wherein the value of performance indicator is estimated to be achieved by the target asset 210 if it continues operation with current conditions. For example, if the identified trend shows a gradual increase in one operational parameter over time, the system 402 may use this information to estimate a corresponding change in a specific performance indicator. In an example, the identified trends in operational parameters and their respective correlated performance indicator values are included in the estimation model 208 while training and then the estimation model 208 is used for estimating the value of performance indicator(s) 420. The estimation model 208 may also consider multiple trends simultaneously, analyzing complex interactions between various operational parameters to estimate values of performance indicator(s) 420.

At block 920, a report indicating the estimated value of the performance indicator is generated. For example, the first estimation engine 414 includes the values estimated for the performance indicator(s) 420 in a recommendation or estimation report. This report provides operators with a forward-looking view of the asset's expected performance. The report may include detailed insights into the estimated performance indicator(s) 420, their trends, and potential implications for asset operation. It may also suggest proactive measures or adjustments to operational parameters that could optimize performance or mitigate potential issues.

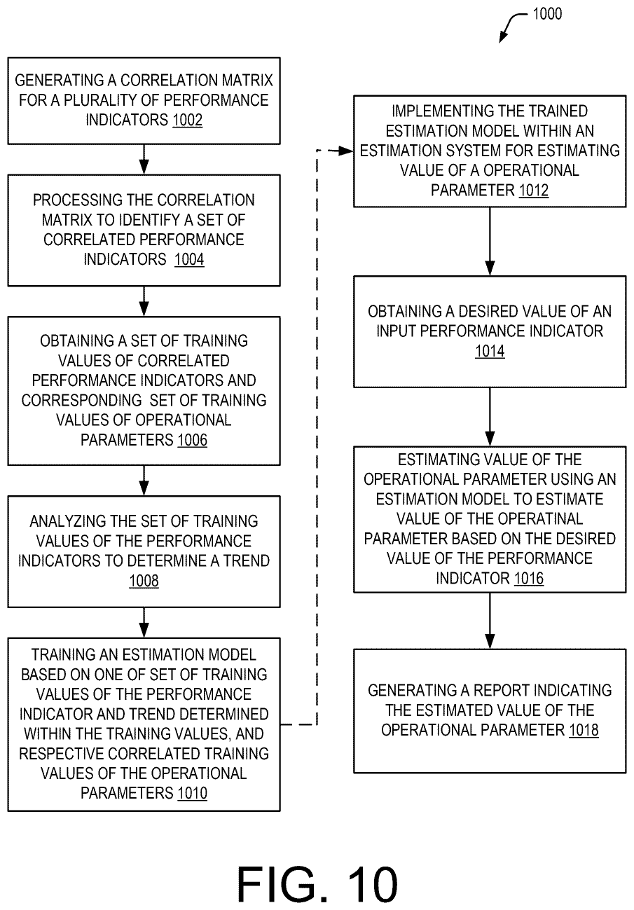

FIG. 10 illustrates another example method 1000 for training an estimation model using which a value of an operational parameter may be estimated, and accordingly the estimated value of the operational parameter may be applied to the asset to achieve a desired performance. Based on the present approaches as described in the context of the example method, a desired value of a performance indicator of the industrial asset is obtained to estimate performance indicators, based on which operational adjustments are identified and implemented. The present example method illustrates training of an estimation model and estimating operational parameters an industrial asset, based on such a trained estimation model. It is pertinent to note that such training and eventual analysis of operational data may not occur in continuity and may be implemented separately without deviating from the scope of the present subject matter.

At block 1002, a correlation matrix for a plurality of performance indicators is generated. For example, the system 502 may generate a correlation matrix that displays correlation coefficients between pairs of performance indicators for an industrial asset, such as target asset 210. This matrix may include indicators, such as, and other relevant performance indicators. In an example, the correlation coefficients in the matrix indicate the strength and direction of the relationship between each pair of indicators, thereby helping to identify which indicators are closely related to each other and may be used for training the machine learning model.

At block 1004, the correlation matrix is processed to identify a set of correlated performance indicators. For example, the second training engine 512 of the system 502 may analyze the correlation matrix to identify performance indicators having correlation coefficients greater than a predefined threshold value. The system 502 may then select the training performance indicators from the plurality of available performance indicators based on this analysis of the correlation matrix. These selected indicators are then used to train the estimation model 208 for estimating operational parameters for the industrial asset, such as target asset 210.

At block 1006, a set of training values of correlated performance indicators and corresponding training values of operational parameters are obtained. For example, the system 502 may obtain the training data 508 from the repository 504 and data included in the training data 508 may be further stored as training performance indicator(s) 514 and training operational parameter(s) 516 in the system 502. In an example, the system 502 obtains set of training values of only correlated operational parameters and corresponding training values of performance indicators which are identified or selected based on the analysis of the correlation matrix. In an example, the training performance indicator(s) 514 and training operational parameter(s) 516 may include set of training values corresponding to each type of performance indicator and each type of operational parameter, respectively.

At block 1008, a set of training values of the performance indicator is analyzed to identify a trend. For example, the second training engine 512 analyzes the training performance indicator(s) 514 to determine a trend within the training values. In an example, the trend within the training values indicates one of a pattern and a direction of change observed in the values of the training performance indicator(s) 514. In an example, the trend identification is performed by the system 502 or the second training engine 512 by using statistical analysis techniques such as time series analysis, regression analysis, or moving averages. These techniques may detect patterns, seasonality, and long-term trends in the performance indicator data. Additionally, more advanced techniques like Fourier analysis or wavelet transforms may be employed to identify complex patterns or cyclical behavior in the training values.

As described in conjunction with FIG. 3 as well, the trend identified within the training performance indicator(s) 514 may include temporal trends as well as the non-temporal trends. In an example, temporal trends are typically identified within the training values of a single performance indicator over time. On the other hand, non-temporal trends are generally identified between the training values of multiple performance indicators.

At block 1010, an estimation model may be trained based on one of the set of training values of performance indicator and the trend identified within the set of values, and corresponding correlated operational parameter. For example, the second training engine 512 may train the estimation model 208 based on one of the training performance indicator(s) 514 and trend determined within the training performance indicator(s) 514, and respective correlated training operational parameter(s) 516. For an instance, if first training engine 312 identify a decreasing trend in a first performance indicator over time, then it may train the estimation model 208 to learn relationship between the identified decreasing trend in first performance indicator with respective changes in the values of one or more operational parameters.

At block 1012, the trained estimation mode is implemented within an estimation system for estimating a value of an operational parameter for a target asset. For example, once the estimation model 208 is trained, the system 602 or the second estimation engine 614 may use a desired value of the performance indicator, such as performance indicator(s) 620, to estimate the value of the operational parameters. Although block 1012 is depicted as following block 1010, the estimation model 208 may be implemented separately without deviating from the scope of the present subject matter.

At block 1014, the system 602 may obtain a desired value of a performance indicator. The desired value of the performance indicator is stored as performance indicator(s) 620 and may be provided by an operator or derived from organizational goals. For example, if the target asset 210 is CCR unit, the desired performance indicator might be a specific hydrocarbon yield or a desired octane number for the reformate. In an example, the system 602 may allow for inputting multiple desired performance indicators simultaneously, such as a combination of several performance indicators. These desired values may be entered by an operator operating on a workstation such as workstation 212 through a user interface. An exemplary user interface 702 is depicted and explained in conjunction with FIG. 7.

At block 1016, an estimation model is used to estimate value of the operational parameter based on the desired value of the performance indicator. For example, the second estimation engine 614 utilizes the estimation model 208 to determine the optimal operational parameters that are needed to achieve the desired value of the performance indicator(s) 620. As described above as well, the estimation model 208 is trained on training data 508 to capture the relationships between operational parameters and performance indicators specific to the target asset 210. In an example, the estimation model 208 considers multiple operational parameters simultaneously to account for their collective impact on the values of the performance indicator(s) 620. For example, in a catalytic reforming unit, it might evaluate combinations of WAIT, hydrogen to hydrocarbon ratio, feed nitrogen content, and reactor pressure to determine their optimal values for achieving the desired hydrocarbon yield or reformate octane number.

Based on the desired value of the performance indicator(s) 620, the second estimation engine 614 subsequently uses the estimation model 208 to estimate values for operational parameters that are likely to achieve the desired performance for the target asset 210. These estimated values for operational parameters are stored in estimated operational parameter(s) 622.

At block 1018, a report indicating the estimated value of the operational parameter is generated. For example, the second estimation engine 614 includes the values for the estimated operational parameter(s) 622 in a recommendation or estimation report and display the report on the display interface. This report provides operators with actionable insights on how to adjust the asset's operational parameters to achieve the desired performance. In another example, the report includes detailed explanations of the recommended parameter adjustments, potential challenges in implementation, and the expected impact on other performance indicators. The report may also suggest a phased approach for implementing changes, considering factors such as current asset conditions and operational constraints.

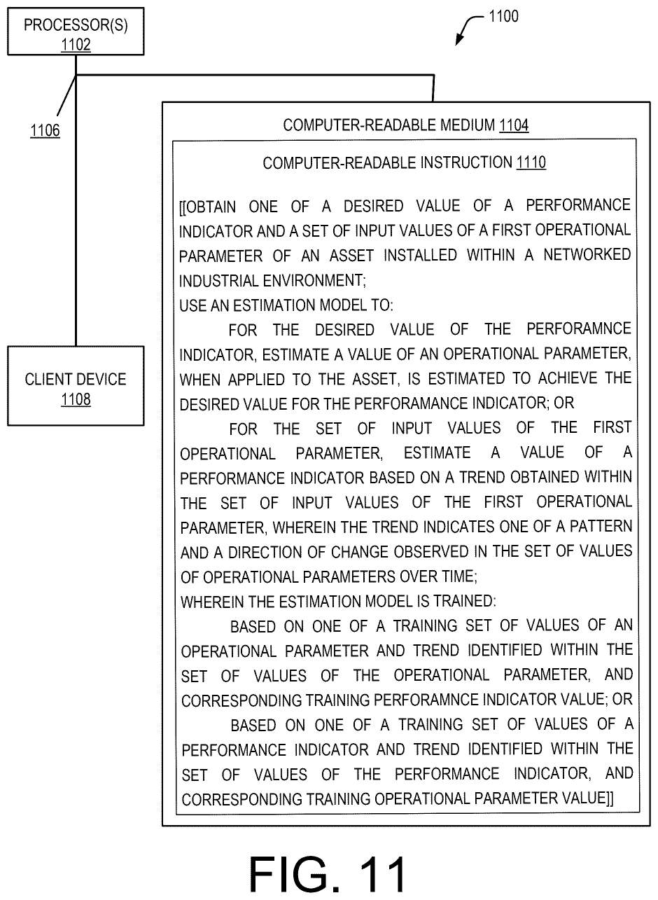

FIG. 11 illustrates a computing environment 1100 implementing a non-transitory computer readable medium for estimating one of a performance indicator value or an operational parameter value, in response to a set of operational parameters values observed in relation to asset over a period of time or in response to a desired performance indicator value, respectively. In an example, the computing environment 1100 includes processor(s) 1102 communicatively coupled to a non-transitory computer readable medium 1104 through a communication link 1106. In an example implementation, the computing environment 1100 may be for example, the system 202. In an example, the processor(s) 1102 may have one or more processing resources for fetching and executing computer-readable instructions from the non-transitory computer readable medium 1104. The processor(s) 1102 and the non-transitory computer readable medium 1104 may be implemented, for example, in system 202 (as has been described in conjunction with the preceding figures).

The non-transitory computer readable medium 1104 may be, for example, an internal memory device or an external memory device. In an example implementation, the communication link 1106 may be a network communication link. The processor(s) 1102 and the non-transitory computer readable medium 1104 may also be communicatively coupled to a computing device 1108 over the network.

In an example implementation, the non-transitory computer readable medium 1104 includes a set of computer readable instructions 1110 (referred to as instructions 1110) which may be accessed by the processor(s) 1102 through the communication link 1106. Referring to FIG. 11, in an example, the non-transitory computer readable medium 1104 includes instructions 1110 that cause the processor(s) 1102 to perform operations for estimating and optimizing performance of an industrial asset, such as target asset 210. The instructions 1110 may be executed to obtain one of a desired value of a performance indicator or a set of input values of a first operational parameter of a target asset 210 installed within a networked industrial environment, such as environment 200.

Once the desired value or input values are obtained, the instructions 1110 may cause the processor(s) 1102 to use an estimation model to perform one of two operations. For example, if a desired value of a performance indicator is provided, the estimation model 208 estimates a value of an operational parameter that, when applied to the target asset 210, is estimated to achieve the desired value for the performance indicator. In such a case, the desired value of the performance indicator is provided as input to the estimation model 208 to generate corresponding operational parameter values. The estimation model 208 may use its trained knowledge of the relationships between performance indicators and operational parameters to determine the optimal parameter settings that are likely to result in the desired performance outcome.

On the other hand, if a set of input values of a first operational parameter is obtained from the target asset 210, the estimation model 208 estimates a value of a performance indicator based on a trend identified within the set of input values of the first operational parameter. In such a case, after obtaining the set of input values of operational parameter, the trend within the input values is identified to indicate patterns or directions of change in the operational parameter over time. This trend may include temporal patterns such as increasing or decreasing trends, cyclical variations, or sudden shifts, as well as non-temporal patterns like correlations or threshold behaviors. The estimation model 208 then uses this trend information to estimate the likely impact on relevant performance indicators, providing estimates of how the asset's performance may change based on the observed operational parameter trends.

In an example, the instructions 1110 may cause the processor(s) 1102 to obtain a set of values of a second operational parameter of the target asset 210, in addition to the first operational parameter. The first estimation engine 414 then analyzes the set of values of both the first operational parameter and the second operational parameter to identify trends between these two parameters. This results in identification of complex relationships and interdependencies between different operational parameters that may not be apparent when examining each parameter in isolation. For instance, in a catalytic reforming unit, the instructions 1110 may cause the processor(s) 1102 to analyze the relationship between the WAIT and the hydrogen to hydrocarbon ratio. The identified trend may indicate how changes in one parameter correlate with changes in the other, such as an inverse relationship where an increase in WAIT corresponds to a decrease in the hydrogen to hydrocarbon ratio. Subsequently, this identified trend along with other training data is used as input for the estimation model 208 to estimate the value of performance indicator.

As described in conjunction with previous figures, the estimation model 208, when used to estimate the value of operational parameter, is trained based on one of set of training values of the performance indicator and trend determined within the training values, and respective correlated training values of the operational parameter On the other hand, the estimation model 208, when used to estimate the value of performance indicator, is trained based on one of set of training values of the operational parameter and trend determined within the training values, and respective correlated training values of the performance indicator. It may be noted that, depending on the specific application and requirements, the estimation model 208 may be trained using various machine learning techniques, such as regression analysis, neural networks, or decision trees. The training process involves exposing the model to training data that includes both operational parameters and corresponding performance indicators, allowing it to learn the complex relationships between these variables. This enables the model to make accurate predictions in both directions estimating performance based on operational parameters, or suggesting optimal operational parameters to achieve desired performance levels.

Once the performance indicator value or operational parameters are estimated, the instructions 1110 may cause the processor(s) 1102 to generate a report detailing the estimation results. This report may include the estimated values, confidence intervals, potential impacts on asset performance, and required actions. The report may also provide visualizations such as graphs or charts to illustrate trends and relationships between operational parameters and performance indicators. Additionally, the report may offer recommendations for adjusting operational parameters to optimize performance or achieve specific targets. In some cases, the report may include comparative analysis with historical data or industry benchmarks to provide context for the estimations. The generated report may be displayed on the computing device 1108 on a workstation, such as workstation 212, or transmitted to relevant stakeholders for review and decision-making purposes.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor; and
a machine-readable storage medium comprising instructions executable by the processor to:
obtain a set of values of a first operational parameter of an asset installed within a networked industrial environment;
obtain, based on the analysis of the set of values of the first operational parameter, a trend, wherein the trend indicates one of a pattern and a direction of change observed in the set of values of first operational parameter over time; and
use an estimation model to estimate value of a performance indicator of the asset based on the identified trend and the set of values of the first operational parameter, wherein the estimation model is trained based on one of a set of training values of a training operational parameter and trend identified within the set of values of the training operational parameter, and corresponding training performance indicator value.

2. The system of claim 1, wherein the instructions executable by the processor to:
obtain a set of values of a second operational parameter of the asset; and
obtain, based on the analysis of the set of values of the first operational parameter and the second operational parameter, the trend between the two parameters, wherein the trend indicates one of pattern and the direction of change observed in the set of values of the first and the second operational parameters.

3. The system of claim 1, wherein the instructions executable by the process to:
based on the estimated value of the performance indicator, cause to generate a report indicating the estimated value of the performance indicator and required action to be taken for the asset.

4. The system of claim 1, wherein the instructions executable by the processor to:
generate a correlation matrix for a plurality of operational parameters, wherein the correlation matrix displays correlation coefficients between pairs of operational parameters;
process the correlation matrix to identify correlated operational parameters having correlation coefficient greater than a predefined threshold value of the coefficient; and
based on the processing of the correlation matrix, select the correlated operational parameter from the plurality of operational parameters for estimating the value of performance indicator.

5. The system of claim 1, wherein the trend comprises temporal trends and non-temporal trends between values of operational parameters, wherein the temporal trend comprises a short-term fluctuation, long-term trend, cyclic trend, seasonal variations, sudden spikes, sudden drops, periods of stability, rate of change over different time scales, and moving averages and the non-temporal trends comprises linear correlation, inverse relation, non-linear correlation, hysteresis relation, oscillatory relation, ratio relation, lag relation, conditional relation, and threshold relation.

6. The system of claim 1, wherein the asset installed within the networked industrial environment is one of a continuous catalytic reforming (CCR) unit, distillation column, fluid catalytic cracking (FCC) unit, hydrotreating unit, steam cracker, polymerization reactor, boiler, compressor station, heat exchanger network, cooling tower, electrolysis cell, absorption tower, crystallization unit, fermentation tank, extruder, and filtration unit.

7. The system of claim 6, wherein when the asset is the CCR unit, the operational parameter comprises hydrocarbon yield, actual delta temperature, weighted average inlet temperature (WAIT), hydrogen to Hydrocarbon ratio, feed nitrogen content, spent coke content, feed naphthene content, feed aromatics content, feed paraffins content, liquid hourly space velocity (LHSV), average reactor pressure, feed naphthene to aromatics ratio, average catalyst chloride content, and mass feed rate.

8. The system of claim 1, wherein the performance indicator comprises hydrocarbon yield, reformate octane number, conversion rate, product purity, energy efficiency, catalyst activity, throughput, product recovery, hydrogen yield, sulphur content, aromatics content, pressure drop, cycle length, and operating margin.

9. A method comprising:
obtaining a set of training values of a performance indicator and corresponding set of training values of an operational parameter;
obtaining, based on an analysis of the set of training values of the performance indicator, a trend, wherein the trend indicates one of a pattern and a direction of change observed in the set of training values of the performance indicator; and
training an estimation model based on one of set of training values of the performance indicator and trend determined within the set of training values, and respective correlated training values of the operational parameter, wherein the estimation model, when trained, is to estimate values of the operational parameter based on a desired value of an input performance indicator of an asset.

10. The method of claim 9, wherein the trend comprises temporal trends and non-temporal trends between values of operational parameters, wherein the temporal trend comprises a short-term fluctuation, long-term trend, cyclic trend, seasonal variations, sudden spikes, sudden drops, periods of stability, rate of change over different time scales, and moving averages and the non-temporal trends comprises linear correlation, inverse relation, non-linear correlation, hysteresis relation, oscillatory relation, ratio relation, lag relation, conditional relation, and threshold relation.

11. The method of claim 9, wherein when the asset is a continuous catalytic reforming (CCR) unit, the operational parameters comprises at least one of hydrocarbon yield, actual delta temperature, weighted average inlet temperature (WAIT), hydrogen to Hydrocarbon ratio, feed nitrogen content, spent coke content, feed naphthene content, feed aromatics content, feed paraffins content, liquid hourly space velocity (LHSV), average reactor pressure, feed naphthene to aromatics ratio, average catalyst chloride content, and mass feed rate.

12. The method of claim 9, wherein the performance indicator comprises at least one of hydrocarbon yield, reformate octane number, conversion rate, product purity, energy efficiency, catalyst activity, throughput, product recovery, hydrogen yield, sulphur content, aromatics content, pressure drop, cycle length, and operating margin.

13. A non-transitory computer-readable medium comprising instructions, the instructions being executable by a processing resource to:
obtain one of a desired value a performance indicator and a set of input values of a first operational parameter of an asset installed within a networked industrial environment;
use an estimation model to:
for the desired value of the performance indicator, estimate a value of an operational parameter that, when applied to the asset, is estimated to achieve the desired value for the performance indicator; or
for the set of input values of the first operational parameter, estimate a value of a performance indicator based on a trend obtained within the set of input values of the first operational parameter, wherein the trend indicates one of a pattern and a direction of change observed in the set of values of operational parameters over time;
wherein the estimation model is trained:
based on one of a training set of values of an operational parameter and trend identified within the set of values of the operational parameter, and corresponding training performance indicator value; or
based on one of a training set of values of a performance indicator and trend identified within the set of values of the performance indicator, and corresponding training operational parameter value.

14. The non-transitory computer-readable medium of claim 13, wherein the instructions are further executable to:
obtain, based on the analysis of the set of input values of the input operational parameter, the trend, wherein the trend comprises temporal trends and non-temporal trends between values of operational parameters, wherein the temporal trend comprises a short-term fluctuation, long-term trend, cyclic trend, seasonal variations, sudden spikes, sudden drops, periods of stability, rate of change over different time scales, and moving averages and the non-temporal trends comprises linear correlation, inverse relation, non-linear correlation, hysteresis relation, oscillatory relation, ratio relation, lag relation, conditional relation, and threshold relation.

15. The non-transitory computer-readable medium of claim 13, wherein the instructions are executable to:
obtain a set of values of a second operational parameter of the asset; and
obtain, based on the analysis of the set of values of the first operational parameter and the second operational parameter, the trend between the two parameters, wherein the trend indicates one of pattern and the direction of change observed in the set of values of the first and the second operational parameters

16. The non-transitory computer-readable medium of claim 13, wherein the instructions are executable to:
cause to generate a recommendation report specifying one of estimated value of the operational parameter and the estimated value of the performance indicator.

17. The non-transitory computer-readable medium of claim 13, wherein the asset installed within the networked industrial environment is one of a chemical processing unit, petrochemical processing unit, refining unit, oil and gas production unit, power generation unit, manufacturing unit, material handling unit, water treatment unit, food processing unit, unit, water treatment unit, food processing unit, pharmaceutical production unit, paper processing unit, metallurgical processing unit, mining and mineral processing unit, textile processing units, electronics manufacturing unit, automotive manufacturing units, aerospace manufacturing unit, waste management unit, renewable energy production unit, agricultural processing unit, and biotechnology processing unit.

18. The non-transitory computer-readable medium of claim 13, wherein the operational parameters comprises input material composition, input material flow rate, input material temperature, input material pressure, reactor temperature, reactor pressure, reaction time, catalyst type, catalyst concentration, catalyst activity, feed rate, product yield, product composition, product quality metrics, energy consumption, utility consumption, equipment efficiency metric, process control variables, environmental conditions, equipment vibration levels, equipment wear indicators, maintenance schedules, production rate, inventory levels, raw material costs, product market prices, equipment uptime, equipment downtime, safety indicators, emissions levels, waste generation rates, recycling rates, and labor utilization.

19. The non-transitory computer-readable medium of claim 17, wherein when the asset is a continuous catalytic reforming (CCR) unit, the operational parameter comprises at least one of hydrocarbon yield, actual delta temperature, weighted average inlet temperature (WAIT), hydrogen to Hydrocarbon ratio, feed nitrogen content, spent coke content, feed naphthene content, feed aromatics content, feed paraffins content, liquid hourly space velocity (LHSV), average reactor pressure, feed naphthene to aromatics ratio, average catalyst chloride content, and mass feed rate.

20. The non-transitory computer-readable medium of claim 13, wherein the performance indicator comprises product yield, product quality metrics, conversion efficiency, energy efficiency, resource utilization efficiency, throughput, production rate, product recovery rate, product composition, product purity, catalyst performance metrics, equipment efficiency, process stability indicators, cycle time, environmental impact metrics, safety performance indicators, equipment reliability metrics, maintenance efficiency, inventory turnover, customer satisfaction metrics, on-time delivery rate, defect rate, waste reduction metrics, resource consumption rate, emissions levels, compliance metrics, and productivity indicators.
